(19) United States
(12) Patent Application Publication
(10) Pub. No.: US 2024/0280322 A1
(43) Pub. Date: Aug. 22, 2024

(54) APPARATUS AND METHOD FOR METALLURGICAL HEAT-TREATMENT

(71) Applicant: ROLLS-ROYCE plc, London (GB)

(72) Inventors: Philip D BUTLER, Ashbourne (GB); Sophie CHITTIM, Burton-on-Trent (GB); Alexis LAMBOURNE, Belper (GB)

(73) Assignee: ROLLS-ROYCE plc, London (GB)

(21) Appl. No.: 18/414,820

(22) Filed: Jan. 17, 2024

(30) Foreign Application Priority Data
Jan. 26, 2023 (GB) 2301104.2

(51) Int. Cl. F27D 99/00; C21D 1/34; C25B 1/04; F27D 7/06

(52) U.S. Cl. CPC F27D 99/0033; C21D 1/34; C25B 1/04; F27D 7/06; F27D 2007/063

(57) ABSTRACT

An apparatus for metallurgical heat-treatment includes a solid-oxide electrolyser, a furnace and a heat-exchanger. The electrolyser is arranged to electrolyse water and provide resulting hydrogen to the furnace. A first portion of the hydrogen from the electrolyser is combusted in a combustor to heat the furnace. A second portion provides a treatment atmosphere including hydrogen for the heat-treatment of a metal or metal alloy object. Water vapour output by the combustor is provided to the heat-exchanger which transfers heat within the water vapour to the solid-oxide electrolyser to improve or maintain its efficiency. In contrast to apparatus of the prior art, the apparatus does not produce carbon dioxide at the point of use. By applying waste heat, carried by the water vapour output from the combustor, to the electrolyser, the power consumption of the electrolyser is reduced for a given rate of electrolysis.

### CROSS-REFERENCE TO RELATED APPLICATIONS

This application is based upon and claims the benefit of priority from United Kingdom patent application GB 2301104.2, filed on Jan. 26, 2023, the entire contents of which are hereby incorporated by reference.

### BACKGROUND OF THE INVENTION

### Field of the Invention

The invention relates to apparatus and methods for performing metallurgical heat-treatment, for example hardening, bright annealing, sintering and carbon nitriding.

### Description of Related Art

Currently, natural gas is used for heating in high temperature furnaces. There is an increased drive to reduce greenhouse gas emissions from supply chains and manufacturing processes. This is coupled with a renewed drive to decrease dependency on natural gas more generally. New methods therefore need to be developed for high temperature industrial processes.

### BRIEF SUMMARY OF THE INVENTION

According to an example, an apparatus for metallurgical heat-treatment comprises a solid oxide electrolyser arranged to electrolyse water input at a water input of the solid oxide electrolyser, a heat-exchanger and a furnace comprising a combustor, wherein the solid oxide electrolyser is arranged to provide a flow of hydrogen to the furnace, the combustor is arranged to combust at least a portion of the flow of hydrogen to produce and output a flow of water vapour and the heat-exchanger is arranged to receive at least a portion of the flow of water vapour and transfer heat therein to the solid oxide electrolyser.

The solid oxide electrolyser may be arranged to provide a flow of oxygen to the furnace, the combustor being arranged to combust at least a portion of the flow of hydrogen from the solid oxide electrolyser using at least a portion of the flow oxygen.

The heat-exchanger may be arranged to provide water derived from water vapour received from the combustor to the water input of the solid oxide electrolyser.

The furnace may be arranged to provide a treatment atmosphere for metallurgical heat-treatment within the furnace, the treatment atmosphere comprising hydrogen derived from a portion of the flow of hydrogen from the solid oxide electrolyser. The treatment atmosphere may consist entirely of hydrogen, the combustor being arranged to receive and combust hydrogen from the treatment atmosphere. The treatment atmosphere may consist of hydrogen, the heat-exchanger being arranged to receive hydrogen from the treatment atmosphere and transmit heat from said hydrogen to the solid oxide electrolyser. The heat-exchanger may be arranged to provide hydrogen received from the treatment atmosphere to the furnace.

Where the furnace is arranged to provide a treatment atmosphere for metallurgical heat-treatment within the furnace, the treatment atmosphere comprising hydrogen derived from a portion of the flow of hydrogen from the solid oxide electrolyser, the apparatus may further comprise a second furnace comprising a second combustor,
(i) the solid oxide electrolyser being arranged to provide a second flow of hydrogen to the second furnace;
(ii) the second combustor being arranged to combust a first portion of the second flow of hydrogen; and
(iii) the second furnace being arranged to provide a second treatment atmosphere for metallurgical heat-treatment within the second furnace, the second treatment atmosphere comprising hydrogen derived from a second portion of the second flow of hydrogen;
   the first and second furnaces being arranged such that the first and second treatment atmospheres are coupled together such that hydrogen may be pass from the first treatment atmosphere to the second treatment atmosphere.

Where the furnace is arranged to provide a treatment atmosphere for metallurgical heat-treatment within the furnace, the treatment atmosphere comprising hydrogen derived from a portion of the flow of hydrogen from the solid oxide electrolyser, the furnace may be arranged to receive a second gas, for example nitrogen, and to provide a treatment atmosphere for metallurgical heat-treatment within the furnace, the treatment atmosphere comprising an endothermic mixture of hydrogen and the second gas.

The furnace may be arranged to receive an inert gas, for example one of helium, neon, argon, krypton, xenon, radon and nitrogen or a mixture of any two or more of helium, neon, argon, krypton, xenon, radon and nitrogen, and provide a treatment atmosphere for metallurgical heat-treatment within the furnace, the treatment atmosphere comprising the inert gas. Alternatively, the furnace may be arranged to receive two or more gaseous inputs, for example carbon monoxide and carbon dioxide, and provide a treatment atmosphere for metallurgical heat-treatment within the furnace, the treatment atmosphere comprising an endothermic mixture of gases derived from the two or more gaseous inputs.

According to an example, a method of metallurgical heat-treatment comprises the steps of:
(i) electrolysing water using a solid oxide electrolyser to generate a flow of hydrogen;
(ii) providing the flow of hydrogen to a furnace;
(iii) combusting at least a portion of the flow of hydrogen to heat the furnace and produce and output a flow of water vapour;
(iv) transferring heat from the flow of water vapour to the solid oxide electrolyser; and
(v) heating a metal or a metal alloy object within the furnace.

The method may further comprise the step of providing a flow of oxygen generated in step (i) to the furnace, step (iii) being carried out using at least a portion of the flow of oxygen.

The method may further comprise the step of providing water derived from at least a portion of the flow of water vapour to the solid oxide electrolyser and electrolysing that water in step (i).

The method may further comprise the step of generating a treatment atmosphere for metallurgical heat-treatment within the furnace, the treatment atmosphere comprising a portion of the hydrogen generated in step (i), step (iv) being carried out by heating the metal or metal alloy object within the treatment atmosphere.

The treatment atmosphere may be generated by mixing a second gas, for example nitrogen, with the portion of hydrogen to produce an endothermic mixture.

Alternatively the method may be a method of hydrogen-desorption, hydrogen-degassing or sintering of a metal alloy comprising either neodymium, iron and boron or samarium and cobalt, optionally comprising the step of providing hydrogen released during the method to another process for embrittlement, decrepitation or disproportionation of that metal alloy. Alternatively, the method may be a method of embrittlement, decrepitation or disproportionation of a metal alloy comprising either neodymium, iron and boron or samarium and cobalt, optionally comprising the step of utilising hydrogen received from another process for hydrogen-desorption, hydrogen-degassing or sintering of that metal alloy.

The method may further comprise the step of generating a treatment atmosphere for metallurgical heat-treatment within the furnace, the atmosphere comprising an inert gas, for example one of helium, neon, argon, krypton, xenon, radon and nitrogen or a mixture of two or more of helium, neon, argon, krypton, xenon, radon and nitrogen, step (iv) being carried out by heating the metal or metal alloy object within the treatment atmosphere. Alternatively, the method may further comprise the step of generating a treatment atmosphere within the furnace for metallurgical heat-treatment by mixing two or more gases, for example carbon monoxide and carbon dioxide, to produce an endothermic mixture, and wherein step (iv) is carried out by heating the metal or metal alloy object within the treatment atmosphere.

### BRIEF DESCRIPTION OF THE SEVERAL VIEWS OF THE DRAWINGS

Examples are described below with reference to the accompanying drawings in which:

FIGS. 1 & 2 show first and second example apparatus;

FIG. 3 shows a flowchart of an example method;

FIGS. 4 & 6 shows processes for the manufacture of certain types of permanent magnet; and

FIGS. 5, 7 & 8 shows processes for the recycling of certain types of permanent magnet.

### DETAILED DESCRIPTION OF THE INVENTION

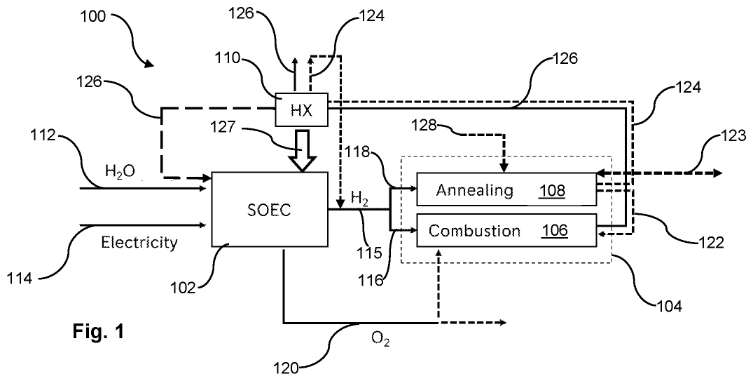

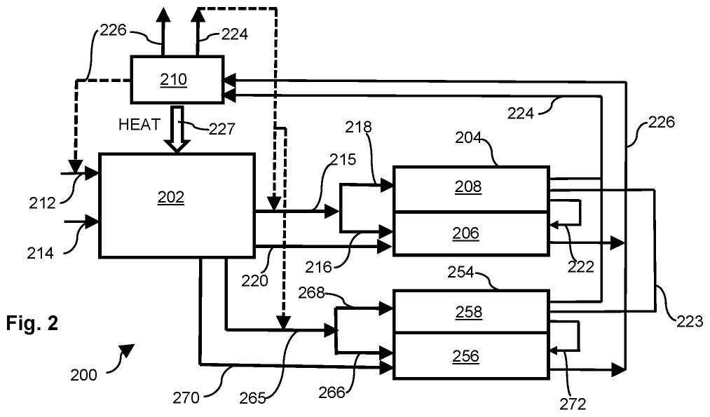

FIG. 1 shows a first example apparatus 100 for metallurgical heat-treatment, the apparatus comprising a solid-oxide electrolyser 102, a furnace 104 and a heat-exchanger 110. In operation of the apparatus 100, water 112 is introduced into the solid-oxide electrolyser 102, converted to steam and electrolysed by an electrical supply 114 to produce flows 115, 120 of hydrogen and oxygen. The flow 115 of hydrogen is divided into a first portion 116 which is combusted in a combustor 106 to heat the furnace 104 and a second portion 118 which is used to provide a hydrogen-rich treatment atmosphere 108 within the furnace 104, in which treatment atmosphere 108 a metal or metal alloy object (not shown) is to be heat-treated. A hydrogen-rich treatment atmosphere is often needed to keep the surface of a metal object clean and oxide-free during heat-treatment, for example to reduce iron oxide to iron, and is used in the following metallurgical heat-treatment processes:
annealing (bright, non-ferrous metals, stainless steel, electrical steels, low-carbon steels;
neutral hardening;
brazing;
sintering (both ferrous and non-ferrous metals);
vacuum processes.

The whole or part of the flow 120 of oxygen produced by the solid-oxide electrolyser 102 may be provided to the combustor 106 for combustion of the portion 116 of the flow 115 of hydrogen produced by the solid-oxide electrolyser 102. Alternatively, the combustor 106 may utilise ambient air. A first portion 122 of hydrogen exiting the atmosphere 108 may optionally also be combusted within the combustor 106. A second portion 124 of hydrogen existing the atmosphere 108, together with the combustion product 126 (water vapour) output from the combustor 106, are provided to a heat-exchanger 110 which transfers heat 127 from these gases to the solid-oxide electrolyser 102 to improve or maintain its operating efficiency. Thus, a portion 127 of heat from the furnace 104 is recycled and applied to the solid-oxide electrolyser 102. The second portion 124 of hydrogen exiting the atmosphere 108 and the combustion product (water vapour) 126 exiting combustor 106 are vented from the apparatus 100 at heat-exchanger outputs 124, 126 respectively.

Soft magnetic materials such as those used in hybrid propulsion systems for automotive or aerospace applications use hydrogen atmosphere heat-treatments. These typically use a pure, dry hydrogen atmosphere furnace (low oxygen, low water, dew point <−50° C.) in order to achieve the best magnetic properties. All soft magnetic heat treatment cycles consist of three basic steps, namely:
1. a gradual temperature increase at a controlled ramp rate, under a hydrogen atmosphere;
2. an extended hold of high temperature (typically 2 to 8 hours at 750° C. to 1150° C.), depending on the alloy being treated, during which time impurities from the surface and sub-surface of an object being treated are ejected and chemically reduced by the hydrogen atmosphere, and a magnetically permeable microscopic structure is formed and optimised by grain growth and domain ordering; and
3. a reduction in temperature at a controlled ramp rate during which the microscopic structure which governs the mechanical and magnetic properties becomes fixed and ‘locked in’ to the material structure.

Magnetic alloys heat treated in this way include (but are not limited to) cobalt-iron alloys, nickel-iron alloys, silicon steels and amorphous alloys such as mu-metal.

For some heat-treatment processes, the treatment atmosphere 108 is required to be a mixture of hydrogen and an inert gas, such as nitrogen or argon for example. In this case, the treatment atmosphere 108 is provided with an additional input 128 for the inert gas. A treatment atmosphere which is mixture of hydrogen and either nitrogen or argon works well for bright annealing, annealing of stainless steel, alloy steel or non-iron and sintering. A treatment atmosphere which is a mixture of hydrogen and nitrogen works also for neutral hardening. The output flow of hydrogen 115 from the solid-oxide electrolyser 102 is sufficiently pure (98-99.9%) as to be regarded as so-called ‘dry hydrogen’.

Optionally, water vapour 126 output from the combustor 106 of the furnace 104 may be input to the solid-oxide electrolyser 102. For example, instead of being vented from the heat-exchanger 110, the water vapour 126 may be directed to the water input 122 of the solid oxide electrolyser 102. Optionally, an input/output line 123 may be provided, via which hydrogen may be introduced into the treatment atmosphere 108 from other apparatus, similar to the apparatus 100, in which a metal or metal alloy object is subjected to a process in which hydrogen is released (e.g. during de-gassing, sintering or desorption steps of the processes described below for the manufacture or recycling of certain permanent magnets). This is especially useful where a metal or metal-alloy object being processed within the treatment atmosphere 108 absorbs hydrogen (e.g. during decrepitation, embrittlement or disproportionation steps in the processes described below for the manufacture or recycling of certain permanent magnets). Similarly, if a metal or metal alloy object being heated within the furnace releases hydrogen, excess hydrogen may be vented via the input/output line 123, for example to another apparatus similar to the apparatus 100 in which an object being processed absorbs hydrogen.

FIG. 2, in which reference numerals differ by 100 from those labelling corresponding parts in FIG. 1, shows a second example apparatus 200, the apparatus including like first and second furnaces 204, 254 respectively having combustors 206, 256 respectively arranged to combust hydrogen provided by solid oxide electrolyser 202. Water vapour 226 output from both furnaces 204, 254 is provided to heat-exchanger 210; heat within the water vapour 226 is transferred to the solid oxide electrolyser 202. An input/output line 223 connects atmospheres 208, 258 of the two furnaces 204, 254 so that hydrogen may be transferred between the atmospheres 208, 258 of the furnaces 204, 254. A first process which releases hydrogen from a first metal or metal alloy object may carried out in one furnace at the same time as a second process, in which hydrogen is absorbed by a second metal or metal alloy object, is carried out in the other furnace. Hydrogen 224 from first and second treatment atmospheres 208, 258 may be input to heat-exchanger 210 in order to transfer heat in that hydrogen to solid oxide electrolyser 202, thus assisting its efficient operation. That hydrogen may subsequently be re-applied to the furnaces 204, 254. The apparatus 100, 200 do not produce carbon dioxide at the point of use. Negative impacts on climate change may be eliminated entirely if the solid oxide electrolysers 102, 202 are operating using green electricity.

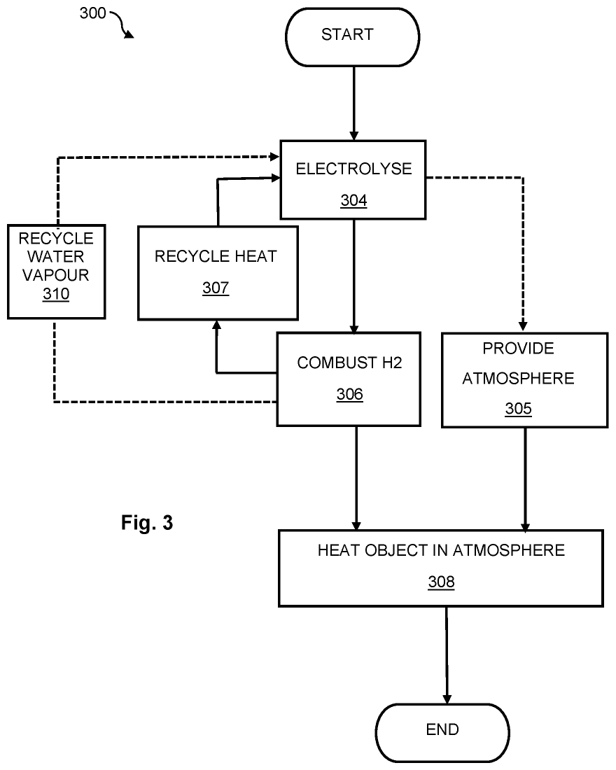

FIG. 3 shows a flow chart of a process 300 for metallurgical heat-treatment of a metal object, which process may be carried out using the apparatus 100 of FIG. 1. In a first step 304, water is electrolysed using a solid oxide electrolyser to produce hydrogen which is combusted 306 to provide heat. A metal or metal alloy object to be treated is heated 308 using that heat in a treatment atmosphere the composition of which depends on the exact nature of the treatment. Optionally, the treatment atmosphere, or a part of it, is provided 305 by hydrogen generated in the electrolysis step 304. Waste heat resulting from combustion of hydrogen is recycled and input to the solid-oxide electrolyser in a heat-recycling step 307. For example, waste heat within water vapour resulting from combustion of hydrogen may be applied to the solid oxide electrolyser by means of a heat-exchanger. Optionally, water vapour (or a portion thereof) generated by combustion of hydrogen in step 306 may be used in the electrolysis step 304, thus recycling 310 water generated by the combustion of hydrogen.

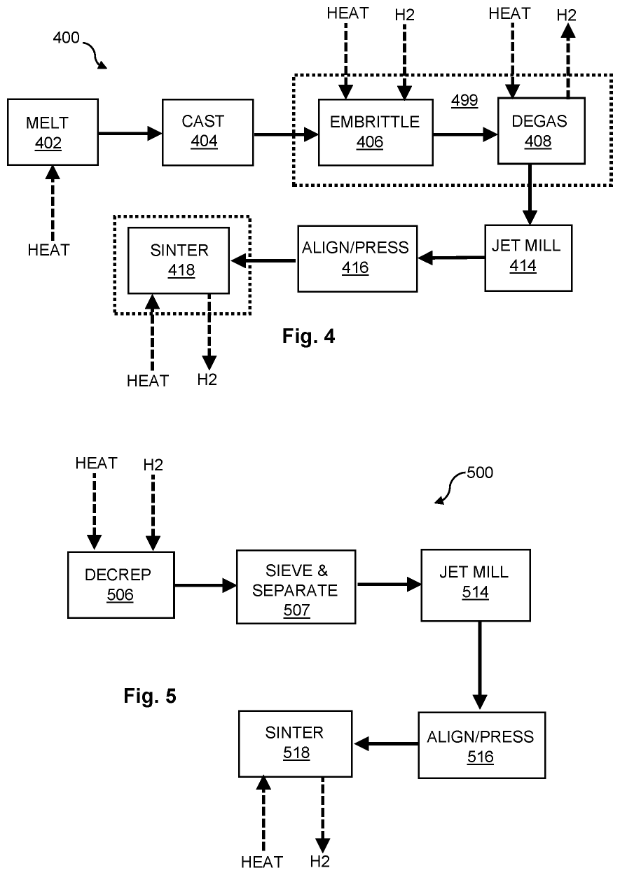

FIG. 4 shows a process 400 for the manufacture of new NdFeB magnets. Following melting 402 of materials from which the magnets are to be made, the resulting melt is cast 404 to form so-called “book-moulded” NdFeB ingots. The ingots are then embrittled 406 by hydrogen-decrepitation by exposing them to a treatment atmosphere of hydrogen and then crushed to form coarse powder. During embrittlement, hydrogen is absorbed into the NdFeB material of the ingots by diffusion along the rare earth (RE) rich grain boundaries and subsequently into the magnetic matrix, creating both a RE-hydride and a Nd₂Fe₁₄B interstitial hydride. The formation of the hydrides within the ingot material creates a volume expansion and internal stress within the very brittle cast material, causing inter- and trans-granular fracturing and forming a coarse, friable powder, avoiding the need for energy-intensive mechanical crushing, whilst making it easier to mill into a very fine powder using processes such as jet milling, ball milling or crushing.

The coarse powder is then heated to approximately 500° C. in a partial-degassing step 408, during which hydrogen is desorbed. Hydrogen released in step 408 may be recovered and combusted to provide heating of certain other process steps (melting 402, sintering 418) and/or used in the decrepitation of a subsequent batch of book-moulded ingots.

Some hydrogen is retained in the powder through a subsequent processing step of pressing and aligning 416 to produce a so-called ‘green’ compact. In a final sintering step 418, the “green compact is heated to more than 1000° C. and the remaining hydrogen is released. As for the partial degassing step 408, the hydrogen released from the material and can be recovered and re-used for other process steps, such as hydrogen decrepitation of a subsequent batch of cast ingots or combustion to provide heat for melting or sintering.

The steps 402, 406, 408, 418 of melting, embrittlement, partial-degassing and sintering respectively each require the application of heat. The step 406 of embrittlement requires application of hydrogen. Hydrogen is released in the steps 408, 418 of de-gassing and sintering respectively.

Steps 406 and 408, collectively designated 499 in FIG. 3, may be carried out using the apparatus 100 of FIG. 1. Similarly, the step 318 of sintering may be carried out using the apparatus 100 of FIG. 1. If a single instance of the apparatus 100 is used, intermediate product must be removed from the apparatus 100 between steps 499 and 418 in order to allow steps 414, 416 to be carried out. If the process 400 is carried out such that each step 402-418 is carried out simultaneously on a series of intermediate product batches, each at a respective step in the process 400, the apparatus 200 of FIG. 2 may be used, with each of steps 499, 418 being carried out in a respective furnace 204, 254 with any excess hydrogen generated in one furnace treatment atmosphere 208, 258 being transferred via the input/output line 223 to the other furnace treatment atmosphere 208, 258 to compensate for a net absorption of hydrogen in that treatment atmosphere.

Generation and use hydrogen in situ allows volumes to be scaled in proportion to process requirements and reduces the need for hydrogen transport or storage.

A process similar to the process 400 of FIG. 4 may also be used to produce new Sm₁Co₅ magnets or Sm₂Co₁₇ magnets. Hydrogen is not required as a process gas, but combustion of hydrogen generated by a solid oxide water electrolyser may be used to generate heat for melting and sintering steps, avoiding use of electrical heating or heating by combustion of natural gas (which has a negative climate change impact).

FIG. 5 shows a process 500 for recycling NdFeB magnets. One or more magnets are embrittled (decreptitated) 506 and crushed to form a fine, de-magnetised, powder. This powder is then sieved 507 to remove other materials such as protective coatings of polymers or Ni-plate. The powder is then jet milled 514 to achieve the correct particle size for re-processing, and then pressed and aligned 516 to form a so-called ‘green compact’. In a final, sintering, step 518 the green compact is heated up to >1000° ° C. and absorbed hydrogen is released. Hydrogen released during sintering 518 can be recovered and re-used for other process steps, such as hydrogen decrepitation of a subsequent batch of magnets and/or combustion to provide heat for the steps of decrepitation 406 and/or sintering 418. Where all steps of the process 500 are carried simultaneously on multiple intermediate product batches, each at a respective step in the process 500, then steps 506, 508 may be carried out simultaneously using either the apparatus 100 of FIG. 1 or the apparatus 200 of FIG. 2. The generation and use of hydrogen in situ allows volumes to be scaled proportional to process requirements and reduces the need for hydrogen transport or storage.

FIG. 6 shows another process 600 for the production of NdFeB magnets in which hydrogen is employed with NdFeB alloys at temperatures greater than 600° C. to produce a reaction known as Hydrogenation-Disproportionation-Desorption-Recombination (HDDR). Suitable materials are melted 602 and cast 604 to form ingots which are then embrittled 606 and crushed to a coarse powder as described above in relation to FIG. 4. Disproportionation 609 is then achieved by heating the coarse powder to 650-850° C. or 650-1000° C. in a treatment atmosphere of hydrogen such that the Nd₂Fe₁₄B matrix phase disproportionates into a mixture of NdH₂, α-Fe and Fe₂B. Subsequently lowering the pressure of hydrogen whilst maintaining an elevated temperature enables hydrogen to desorb 611 from the material, destabilising the disproportionated mixture and causing it to recombine back to the Nd₂Fe₁₄B matrix, but with a grain size of ˜300-500 nm. This transformation can be expressed by the following equation:

$$Disproportionation \to$$

$${Nd}_{2} {Fe}_{14} B + 2 {x H}_{2} ↔ {NdH}_{2 x} + 12 Fe + {Fe}_{2} B$$

$$← Recombination$$

This enables transformation of a large grain (>10 μm) cast microstructure into a much smaller grain size, which greatly increases the coercivity of the material without the need for any additional expensive elements. The powder is then mixed with resin 613 in an aligning field to produce resin-bonded magnets. If all steps of the process 600 are carried simultaneously, each on a respective intermediate product batch, then steps 606, 609, 611 may be carried out simultaneously as a single step 699 using the apparatus 100 of FIG. 1. Alternatively the apparatus 200 of FIG. 2 may be used, with steps 606, 609 being carried out in one of the furnaces 204, 254 and step 611 being carried out in the other of the two furnaces 204, 254.

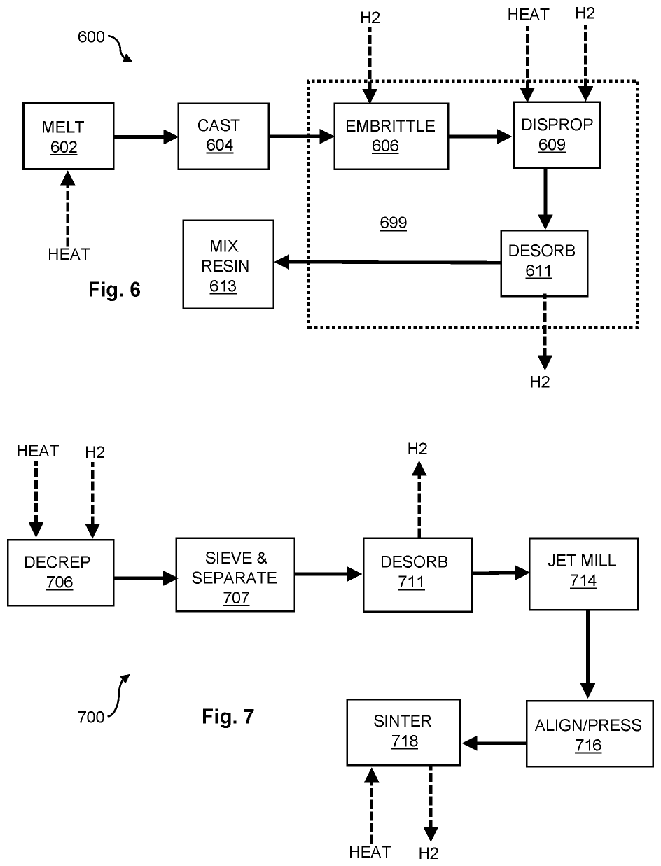

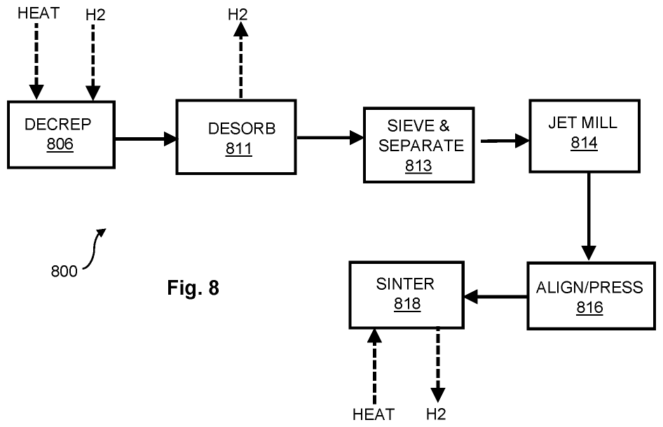

FIG. 7 shows a process 700 by which Sm₂Co₁₇ magnets may be recycled. In a first step 706 a magnet is decrepitated and crushed to a powder. The resulting powder is sieved 707 to separate out and remove other materials such as polymer coating or Ni-plate. After partial de-gassing 711 the powder is jet milled 714 to achieve the correct particle size for re-processing, and as in primary manufacture, the re-processed powder is pressed and aligned 716 to form a ‘green’ compact. In final step 718 the resulting ‘green’ compact is sintered by heating up to >1000° C. and absorbed hydrogen is released. Hydrogen released during desorption 711 and sintering 718 may be used to decrepitate a subsequent batch of magnets to be recycled and/or combusted to provide heat for decrepitation and sintering steps. The process 700 may be carried out on a single batch of magnets using the apparatus 100 of FIG. 1. For a continuous process in which each of a plurality of intermediate product batches is at a respective step of the process 700, the apparatus 200 of FIG. 2 may be used, with the decrepitation step 706 being carried out in one of the furnaces 204, 254 and the sintering step being carried out in the other furnace of the apparatus 200.

As with NdFeB and Sm₂Co₁₇ magnets, hydrogen can be used in a process 800 to recycle Sm₁Co₅ magnets as shown in FIG. 8. When exposed to hydrogen under certain combinations of time, temperature & pressure, the hydrogen diffuses into the magnet material which is absorbed into the material by diffusion along grain boundaries and subsequently into the magnetic grains. The formation of a hydride within the material creates an internal stress within a very brittle material, these internal stresses cause the material to fracture (decrepitate) into a fine powder 806. Following this step hydrogen is de-sorbed 811. This can be a slow process taking around 48 hours at room temperature and pressure. The process can be speeded up by use of a partial pressure (vacuum). Under vacuum conditions the release of hydrogen from the material is strongly endothermic. This decrease in temperature may be used directly or indirectly to cool the desorption working chamber and reduce the pressure, creating a partial pressure (partial vacuum) due to the reduced temperature and pressure of the working volume. This thermally driven vacuum can reduce the energy inputs to the process. As before, the hydrogen released from the material and can be recovered and re-used for other process steps, such as decrepitation of a subsequent next batch of magnets to be recycled, prior to milling, or combusted to provide the heat for the decrepitation 806 or (subsequent) sintering 818 steps. The powder is then sieved 813, to remove other materials such as protective coatings of polymers or Ni-plate, jet milled 814, to achieve the correct particle size for re-processing, and as in primary manufacture, the re-processed powder is pressed and aligned 816 to produce a ‘green’ compact. A final, sintering, step 818 heats the ‘green’ compact up to >1000° C. and absorbed hydrogen is released. The apparatus 100, 200 may be used for the decrepitation 806 and sintering 818 steps.

What is claimed is:

1. Apparatus for metallurgical heat-treatment, the apparatus comprising a solid oxide electrolyser arranged to electrolyse water input at a water input of the solid oxide electrolyser, a heat-exchanger and a furnace comprising a combustor, wherein the solid oxide electrolyser is arranged to provide a flow of hydrogen to the furnace, the combustor is arranged to combust at least a portion of the flow of hydrogen to produce and output a flow of water vapour and the heat-exchanger is arranged to receive at least a portion of the flow of water vapour and transfer heat therein to the solid oxide electrolyser.

2. Apparatus according to claim 1 wherein the solid oxide electrolyser is arranged to provide a flow of oxygen to the furnace and the combustor is arranged to combust at least a portion of the flow of hydrogen from the solid oxide electrolyser using at least a portion of the flow oxygen.

3. Apparatus according to claim 1 wherein the heat-exchanger is arranged to provide water derived from water vapour received from the combustor to the water input of the solid oxide electrolyser.

4. Apparatus according to claim 1 wherein the furnace is arranged to provide a treatment atmosphere for metallurgical heat-treatment within the furnace, the treatment atmosphere comprising hydrogen derived from a portion of the flow of hydrogen from the solid oxide electrolyser.

5. Apparatus according to claim 4 wherein the treatment atmosphere consists of hydrogen and the combustor is arranged to receive and combust hydrogen from the treatment atmosphere.

6. Apparatus according to claim 4 wherein the treatment atmosphere consists of hydrogen and the heat exchanger is arranged to receive hydrogen from the treatment atmosphere and transmit heat from said hydrogen to the solid oxide electrolyser.

7. Apparatus according to claim 6 wherein the heat exchanger is arranged to provide hydrogen received from the treatment atmosphere to the furnace.

8. Apparatus according to claim 4 further comprising a second furnace which comprises a second combustor, wherein:
(i) the solid oxide electrolyser is arranged to provide a second flow of hydrogen to the second furnace;
(ii) the second combustor is arranged to combust a first portion of the second flow of hydrogen; and
(iii) the second furnace is arranged to provide a second treatment atmosphere for metallurgical heat-treatment within the second furnace, the second treatment atmosphere comprising hydrogen derived from a second portion of the second flow of hydrogen;
and wherein the first and second furnaces are arranged such that the first and second treatment atmospheres are coupled together such that hydrogen may be pass from the first treatment atmosphere to the second treatment atmosphere.

9. Apparatus according to claim 4 wherein the furnace is arranged to receive a second gas, for example nitrogen, and to provide a treatment atmosphere for metallurgical heat-treatment within the furnace, the treatment atmosphere comprising an endothermic mixture of hydrogen and the second gas.

10. Apparatus according to claim 1 wherein the furnace is arranged to receive an inert gas, for example one of helium, neon, argon, krypton, xenon, radon and nitrogen or a mixture of any two or more of helium, neon, argon, krypton, xenon, radon and nitrogen, and provide a treatment atmosphere for metallurgical heat-treatment within the furnace, the treatment atmosphere comprising the inert gas.

11. Apparatus according to claim 1 wherein the furnace is arranged to receive two or more gaseous inputs, for example carbon monoxide and carbon dioxide, and provide a treatment atmosphere for metallurgical heat-treatment within the furnace, the treatment atmosphere comprising an endothermic mixture of gases derived from the two or more gaseous inputs.

12. A method of metallurgical heat-treatment, the method comprising the steps of:
(i) electrolysing water using a solid oxide electrolyser to generate a flow of hydrogen;
(ii) providing the flow of hydrogen to a furnace;
(iii) combusting at least a portion of the flow of hydrogen to heat the furnace and produce and output a flow of water vapour;
(iv) transferring heat from the flow of water vapour to the solid oxide electrolyser; and
(v) heating a metal or a metal alloy object within the furnace.

13. A method according to claim 12 further comprising the step of providing a flow of oxygen generated in step (i) to the furnace and wherein step (iii) is carried out using at least a portion of the flow of oxygen.

14. A method according to claim 12 further comprising the step of providing water derived from at least a portion of the flow of water vapour to the solid oxide electrolyser and electrolysing that water in step (i).

15. A method according to claim 12 further comprising the step of generating a treatment atmosphere for metallurgical heat-treatment within the furnace, the treatment atmosphere comprising a portion of the hydrogen generated in step (i), and wherein step (iv) is carried out by heating the metal or metal alloy object within the treatment atmosphere.

16. A method according to claim 15 wherein the treatment atmosphere is generated by mixing a second gas, for example nitrogen, with the portion of hydrogen to produce an endothermic mixture.

17. A method according to claim 15 wherein the method is a method of hydrogen-desorption, hydrogen-degassing or sintering of a metal alloy comprising either neodymium, iron and boron or samarium and cobalt, optionally comprising the step of providing hydrogen released during the method to another process for embrittlement, decrepitation or disproportionation of that metal alloy.

18. A method according to claim 15 wherein the method is a method of embrittlement, decrepitation or disproportionation of a metal alloy comprising either neodymium, iron and boron or samarium and cobalt, optionally comprising the step of utilising hydrogen received from another process for hydrogen-desorption, hydrogen-degassing or sintering of that metal alloy.

19. A method according to claim 12 further comprising the step of generating a treatment atmosphere for metallurgical heat-treatment within the furnace, the atmosphere comprising an inert gas, for example one of helium, neon, argon, krypton, xenon, radon and nitrogen or a mixture of two or more of helium, neon, argon, krypton, xenon, radon and nitrogen, and wherein step (iv) is carried out by heating the metal or metal alloy object within the treatment atmosphere.

20. A method according to claim 12 further comprising the step of generating a treatment atmosphere within the furnace for metallurgical heat-treatment by mixing two or more gases, for example carbon monoxide and carbon dioxide, to produce an endothermic mixture, and wherein step (iv) is carried out by heating the metal or metal alloy object within the treatment atmosphere.
